(19) United States
(12) Patent Application Publication
(10) Pub. No.: US 2022/0134550 A1
(43) Pub. Date: May 5, 2022

(54) CONTROL SYSTEM FOR HAND AND CONTROL METHOD FOR HAND

(71) Applicant: Panasonic Intellectual Property Management Co., Ltd., Osaka (JP)

(72) Inventors: Yuzuka ISOBE, Osaka (JP); Yoshinari MATSUYAMA, Osaka (JP); Tomoyuki YASHIRO, Osaka (JP); Kozo EZAWA, Osaka (JP)

(21) Appl. No.: 17/572,949

(22) Filed: Jan. 11, 2022

Related U.S. Application Data
(63) Continuation of application No. PCT/JP2020/020073, filed on May 21, 2020.

(30) Foreign Application Priority Data
Jul. 12, 2019 (JP) 2019-130622

(51) Int. Cl. B25J 9/16

(52) U.S. Cl. CPC B25J 9/1612; B25J 9/1664; B25J 9/1653; B25J 9/1697

(57) ABSTRACT

A control system for a hand that is connectable to a robot arm and has a tip of which shape is deformable, includes an image acquisition unit that acquires an image of the hand, and a controller that detects at least one specific deformed shape of the hand based on the image acquired by the image acquisition unit, and performs a control on at least one of the hand and the robot arm according to the at least one specific deformed shape detected.

### BACKGROUND

### 1. Technical Field

The present disclosure relates to a control system for a hand and a control method for a hand.

### 2. Description of the Related Art

Patent Literature (PTL) 1 describes a robot control device that controls a robot device including a robot hand that grips an object to be gripped, and includes a first acquisition unit for acquiring visual information of the object to be gripped, a second acquisition unit for acquiring force sensory information on a force acting on the object to be gripped by the robot hand, a calculation unit for calculating the position and orientation of the object to be gripped from the visual information acquired by the first acquisition unit, a derivation unit for deriving variability of the gripping state of the object to be gripped based on the force sensory information acquired by the second acquisition unit, and a control unit for controlling at least one of processes performed by the first acquisition unit or the calculation unit based on the variability of the gripping state of the object to be gripped derived by the derivation unit.
PTL 1 is Unexamined Japanese Patent Publication No. 2017-87325.

### SUMMARY

When a tip of a robot hand is deformable, a force sensor may not function due to the deformation of the tip.

The present disclosure is made in view of the above issue. An object of the present disclosure is to provide a control system for a hand and a control method for a hand capable of determining a gripping state even for a hand having a deformable tip.

The present disclosure provides a control system for a hand that is connectable to a robot arm and has a tip of which shape is deformable, and includes an image acquisition unit that acquires an image of the hand, and a controller that detects at least one specific deformed shape of the hand based on the image acquired by the image acquisition unit, and performs a control on at least one of the hand and the robot arm according to the at least one specific deformed shape detected.

Furthermore, the present disclosure provides a control method for a hand that is connectable to a robot arm and has a tip of which shape is deformable, and includes acquiring an image of the hand, detecting a specific deformed shape of the hand based on the acquired image, and performing a control on at least one of the hand and the robot arm according to the specific deformed shape.

According to the present disclosure, a control system for a hand and a control method for a hand capable of determining a gripping state even for a hand having a deformable tip can be provided.

### BRIEF DESCRIPTION OF DRAWINGS

FIG. 1 is a schematic view illustrating an example of hand 12 connected to robot arm 11.

FIG. 2 is a block diagram illustrating an example of control system 100 for a hand of the present disclosure.

FIG. 3 is a schematic view illustrating an example of the relationship between hand 12 included in robot device 10 and workpiece W, where part (a) is before gripping, part (b) is at the start of gripping, part (c) is when gripping is completed, part (d) is during operation, and part (e) is when the workpiece is released.

FIG. 4 is a flowchart illustrating an example of control (at the start of operation) performed by control system 100 of the present disclosure.

FIG. 5 is a flowchart illustrating an example of control (during operation) performed by control system 100 of the present disclosure.

FIG. 6 is a schematic view illustrating an example of an operation performed by hand 12 gripping workpiece W, where part (a) is at the start of operation, part (b) is at the start of interference between workpiece W and fit-target object 40, part (c) is when the shape of the hand is deformed, and part (d) is when the shape of the hand returns to a second normal gripping shape.

FIG. 7 is a graph illustrating an example of the change in work distance when hand 12 connected to robot arm 11 is controlled by control system 100 of the present disclosure.

FIG. 8 is a graph illustrating an example of the change in work distance when hand 12 connected to robot arm 11 is controlled by control system 100 of the present disclosure.

FIG. 9 is a conceptual view exemplarily illustrating a robot hand with a deformable tip.

### DETAILED DESCRIPTION

(How Present Disclosure has been Made) Robot devices used in factories can perform various operations with interchangeable end effectors attached to a robot arm. For example, a robot hand is used as an end effector to pick parts flowing on a production line in a factory. The robot arm and the end effector (robot hand, etc.) are controlled by a control device (controller) connected to the robot arm.

Conventionally, this control is performed by using feedback from sensors such as an encoder and a force sensor. For example, as in the technique described in PTL 1, the variability of the gripping state of an object to be gripped (workpiece) is derived using a force sensor.

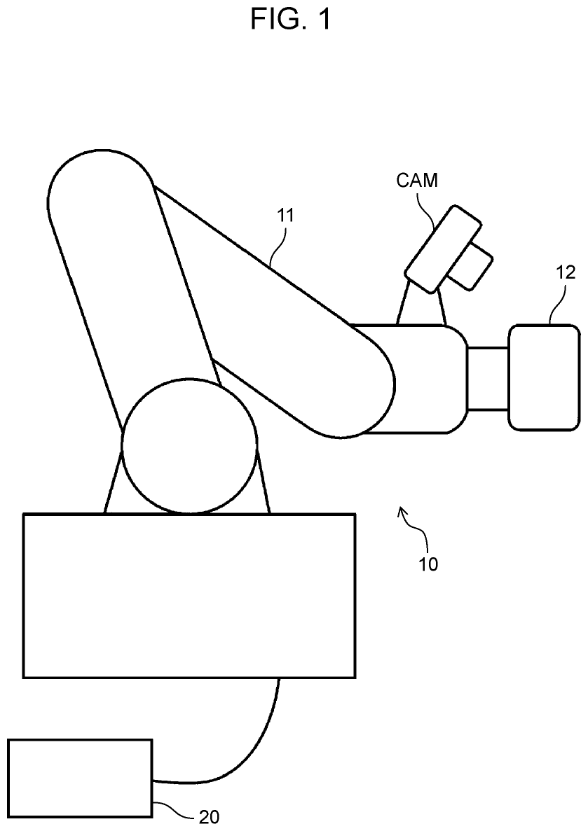

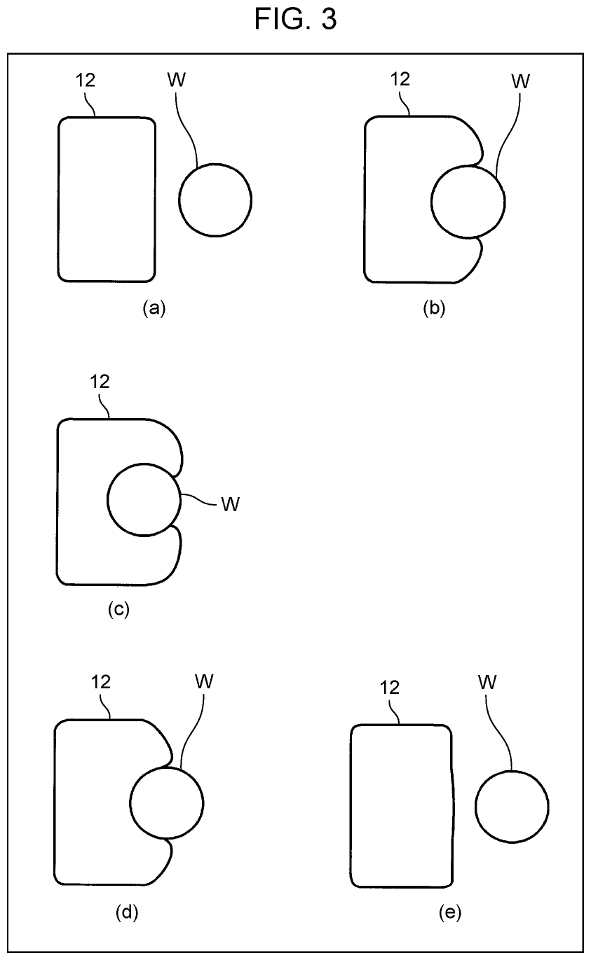

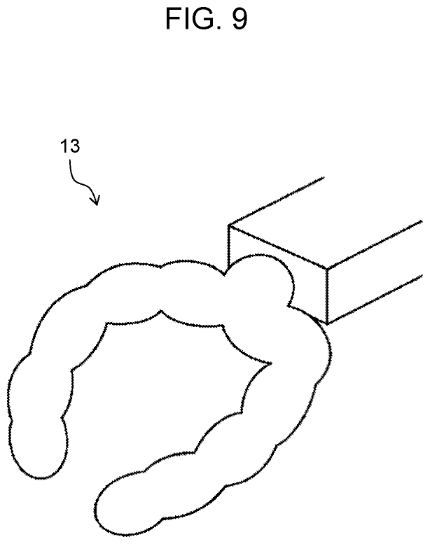

Some robot hands are deformable depending on a workpiece or the like to be gripped. For example, there is a robot hand made of a soft material called a flexible hand or a soft hand (see FIG. 1 and FIG. 3). There is also robot hand 13 equipped with a plurality of articulated fingers of which surfaces are deformable (see FIG. 9). In these robot hands, at least the shape of the tip deforms when the workpiece is gripped. The “tip” means a portion, of the robot hand, which comes into contact with a workpiece or the like. A portion other than the portion (tip) of the robot hand coming into contact with a workpiece or the like may also be deformable.

A robot hand that is, at least the shape of a tip is, deformable as described above is highly applicable for gripping various objects. However, when a workpiece is gripped by such a robot hand, the shape of the hand itself deforms into various shapes. When this happens, a force acting on the robot hand cannot be recognized, and thus the feedback from a force sensor cannot be received correctly. This makes it difficult to accurately control the robot hand based on the feedback from the force sensor.

The robot hand is typically controlled by calculating a formula of law of motion based on inverse kinematics. However, for a robot hand that is, at least the shape of a tip is, deformable, the solution of the formula of law considering the deformation cannot be determined, which means that calculation is impossible. Suppose that calculation is possible, the amount of calculation is enormous, requiring a large amount of calculation time.

Furthermore, to start up a robot arm and an end effector equipped with various sensors, much time is required for setting the sensors. Furthermore, for a robot arm and an end effector equipped with a plurality of sensors, information acquired as feedback from a plurality of sensors comes through a plurality of systems, which makes information processing complicated. Furthermore, for a control performed using artificial intelligence, the learning data for the artificial intelligence is multimodal data, and therefore learning is difficult. Thus, a configuration that does not use such sensors is preferable.

In this regard, in the following exemplary embodiment, the state of a robot hand gripping a workpiece is determined by an image so that the gripping state can be determined even for a hand having a deformable tip. With this configuration, the hand can be controlled with no force sensor.

Furthermore, the above configuration that uses no force sensor or the like can be configured as a sensorless and simple system that does not require any time for setting a sensor. Furthermore, the feedback information from an end effector (robot hand, etc.) can be all put into a captured image captured by a camera. This avoids performing multimodal information processing. It is also beneficial to reduce the channels of information used for machine learning of artificial intelligence.

Hereinafter, an exemplary embodiment in which the configuration and operation of a control system for a hand and a control method for a hand according to the present disclosure are specifically disclosed will be described in detail with reference to the drawings as required. Note that, detailed description more than needed may be omitted. For example, detailed description on already known matters and duplicated description on substantially identical configurations may be omitted. This is to avoid the following description becoming unnecessarily redundant and to help understanding of those skilled in the art. Note that, the attached drawings and the following description are provided for those skilled in the art to fully understand the present disclosure, and are not intended to limit the subject matter set forth in the claims.

### First Exemplary Embodiment

In a following first exemplary embodiment, a case where a flexible hand (soft hand) is used as an end effector connected to a robot arm will be described. However, the same applies to other types of robot hand that is, at least the shape of the tip is, deformable (for example, robot hand 13 as illustrated in FIG. 9).

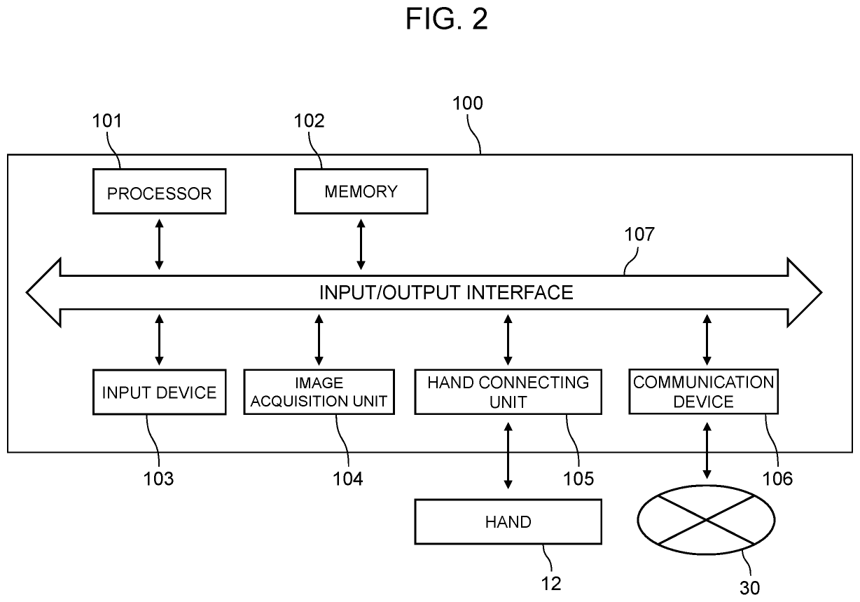

FIG. 1 is a schematic view illustrating an example of hand 12 connected to robot arm 11. FIG. 2 is a block diagram illustrating an example of control system 100 for a hand of the present disclosure. The control system for a hand and the control method for a hand of the present disclosure will be described in detail with reference to FIGS. 1 and 2.

Control system 100 for a hand of the present disclosure is a system for controlling robot device 10 or the like that supports automation in factories.

Robot device 10 includes robot arm 11, and hand 12 disposed at the tip of robot arm 11. Hand 12 is a robot hand that grips a workpiece of various shapes (a target of operation, an object taking various shapes), and is a flexible hand (soft hand) in this example. Thus, hand 12 can be deformed according to the shape of the workpiece. In particular, the shape of the tip of the hand is deformable. In hand 12, for example, a plurality of flexible vacuum suction units is arranged on a surface of hand 12 to suction workpiece W, and thus suctioning, moving, operation, or the like can be performed.

Hand 12, which is a flexible hand, only needs to have flexibility with respect to the workpiece to be gripped. Thus, flexible hands includes a hand formed of a flexible material, and a hand formed of a material that itself has no flexibility but having a flexible structure (for example, a hand made of plastic but is made deformable by a spring or the like).

### (Camera CAM Disposition and Angle of View)

Control system 100 of the present disclosure controls hand 12 based on a captured image captured by camera CAM without using various sensors such as a force sensor. Camera CAM is disposed on hand 12 such that a control based on an image can be performed (see FIG. 1). Furthermore, camera CAM is disposed at a position where hand 12 can be imaged (in particular, near the tip of hand 12). In the example in FIG. 1, camera CAM is disposed near the connection between hand 12 and robot arm 11. However, camera CAM may be disposed at a different place.

### (Configuration of Control System)

FIG. 2 is a block diagram illustrating an example of hardware configuration of control system 100 according to the first exemplary embodiment. Control system 100 controls the movement of robot arm 11 and hand 12.

Control system 100 in the example includes processor 101, memory 102, input device 103, image acquisition unit 104, hand connecting unit 105, communication device 106, and input/output interface 107. Memory 102, input device 103, image acquisition unit 104, hand connecting unit 105, communication device 106, and input/output interface 107 are each connected to processor 101 by an internal bus or the like such that data or information can be input and output.

Processor 101 is composed using, for example, a central processing unit (CPU), a micro processing unit (MPU), a digital signal processor (DSP), or a field programmable gate array (FPGA). Processor 101 functions as a controller for control system 100 to perform a control process of integrally managing operations of the units of control system 100, a process of performing input or output of data or information from or to the units of control system 100, a process of calculating data, and a process of storing data or information. Processor 101 also functions as a controller that controls hand 12.

Memory 102 may include a hard disk drive (HDD), a read only memory (ROM), a random access memory (RAM), or the like, and stores various programs (operation system (OS), application software, etc.) executed by processor 101. Memory 102 may have control information of the target position for each end effector. The control information may be, for example, feature point information or the like.

Input device 103 may include a keyboard, a mouse, and the like, has a function as a human interface for a user, and receives a manipulation input from the user. In other words, input device 103 is used for giving an input or an instruction for various processes performed by control system 100. Input device 103 may be a programming pendant connected to control device 20.

Image acquisition unit 104 is connectable to camera CAM via wire or wirelessly, and acquires an image captured by camera CAM. Control system 100 can appropriately perform image processing on the image acquired by image acquisition unit 104. The image processing may be performed mainly by processor 101. Furthermore, control system 100 may further include an image processing unit (not shown), and the image processing unit may be connected to control system 100. The image processing unit can perform image processing under the control of processor 101.

Hand connecting unit 105 is a component element that secures connection with hand 12, and control system 100 and hand 12 (and robot arm 11) are connected to each other via hand connecting unit 105. This connection may be a wired connection using a connector and a cable or the like, but may alternatively be a wireless connection. When this connection is made, hand connecting unit 105 acquires from hand 12 identification information for identifying hand 12. That is, hand connecting unit 105 functions as an identification information acquisition unit. Processor 101 may further acquire identification information from hand connecting unit 105. With this identification information, the type of connected hand 12 can be identified as a flexible hand.

Communication device 106 is a component element for communicating with the outside via network 30. Note that, this communication may be wired communication or wireless communication.

Input/output interface 107 has a function as an interface through which data or information is input or output from or to control system 100.

The above configuration of control system 100 is an example, so it is not always necessary to include all the above component elements. In addition, control system 100 may further include an additional component element. For example, control system 100 having a box-shape (control device 20) may have wheels to run on its own, carrying robot arm 11 and hand 12 on control system 100.

### (Shape of Hand 12 Gripping Workpiece W)

FIG. 3 is a schematic view illustrating an example of the relationship between hand 12 included in robot device 10 and workpiece W. In FIG. 3, part (a) is before gripping, part (b) is at the start of gripping, part (c) is when gripping is completed, part (d) is during operation, and part (e) is when the workpiece is released. The state of gripping workpiece W by hand 12 will be described with reference to FIG. 3.

In the state in part (a) of FIG. 3, hand 12 is not in contact with workpiece W. By driving robot arm 11, hand 12 is pressed against workpiece W, the shape of the tip of hand 12 is deformed, and the state transitions to the state in part (b) of FIG. 3 and then to the state in part (c) of FIG. 3. The shape of hand 12 in the state in part (c) of FIG. 3 is a first shape of hand 12. The first shape of hand 12 may be the shape that hand 12 takes when moving while gripping workpiece W which is the target of operation.

After gripping workpiece W, hand 12 moves workpiece W to the start position of operation, and performs an operation. Specific examples of the operation are fitting, connecting, fixing, etc. of workpiece W to the target object. Since hand 12 is deformable as described above, hand 12 can take a second shape as illustrated in FIG. 3 (d), for example, different from the first shape. The second shape of hand 12 may be the shape that hand 12 takes when hand 12 performs the operation while holding workpiece W which is the target of operation. After the operation is completed, hand 12 releases workpiece W (see part (e) of FIG. 3).

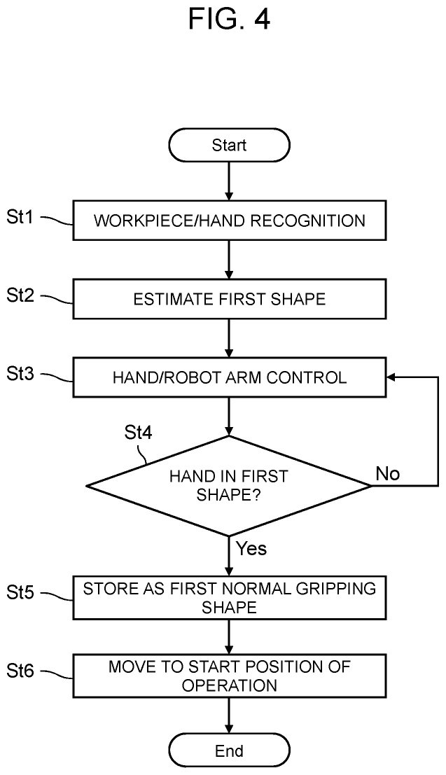

FIG. 4 is a flowchart illustrating an example of a control performed by control system 100 of the present disclosure. This flowchart illustrates an example of a control performed when hand 12 grips workpiece W and moves workpiece W to the start position of operation.

First, processor 101 recognizes workpiece W and hand 12 (step SW. The information for recognizing workpiece W may be input from input device 103 or acquired from a captured image captured by camera CAM. The information for recognizing hand 12 may be acquired from hand 12 via hand connecting unit 105, or alternatively, the information may be previously held in memory 102 and acquired from memory 102. Already recognized information may be stored in memory 102.

Next, processor 101 estimates the first shape (specific shape) of hand 12 according to workpiece W (step St2).

This estimation may be done, for example, by processor 101 acquiring the information on the shape of hand 12 (contour, feature points on hand 12, etc.) according to workpiece W previously stored in memory 102 as a database. Alternatively, it may be configured that the relationship between workpiece W and the shape of hand 12 (contour, feature points on hand 12, etc.) is machine-learned to previously generate a learning model, the information related to workpiece W already recognized in step St1 is input to the learning model, and the estimated shape of hand 12 is output. Estimation of the shape of hand 12 may be done according to the shape of workpiece W as described above, or alternatively, according to the mass, surface roughness, hardness, etc. of workpiece W. Information indicating the mass, surface roughness, hardness, etc. of workpiece W may be input from input device 103 and stored in memory 102.

Next, processor 101 controls hand 12 and robot arm 11 such that hand 12 is deformed into the first shape (steps St3, St4). Controlling hand 12 and robot arm 11 includes operating either hand 12 or robot arm 11, and operating both hand 12 and robot arm 11 simultaneously. This control may be performed, for example, as follows.

Processor 101 controls hand 12 and robot arm 11 (step St3). For example, robot arm 11 is driven by the control by processor 101, hand 12 is pressed against workpiece W, and workpiece W is gripped by hand 12 (see part (a) to part (c) of FIG. 3). Next, processor 101 determines whether the shape of hand 12 is the first shape (specific shape) (step St4). This determination may be made based on a captured image of hand 12 captured by camera CAM and acquired by image acquisition unit 104. If processor 101 determines that the shape of hand 12 is not the first shape (No in step St4), the step returns to step St3, and processor 101 further controls hand 12 and robot arm 11 such that hand 12 takes the first shape (step St3). For example, the suction force of the vacuum suction unit of hand 12 is increased.

When processor 101 determines that the shape of hand 12 is the first shape (Yes in step St4), the current shape of hand 12 is registered (stored) in memory 102 as a first normal gripping shape (step St5). At this time, hand 12 grips workpiece W correctly.

Now, the estimation of the first shape in step St2 and the registration (storing) of the first normal gripping shape in step St5 will be described in more detail.

The first normal gripping shape (step St5) of hand 12 gripping workpiece W is a shape corresponding to the first shape of hand 12. However, hand 12 is deformable as described above. Thus, the first shape, which is the estimated shape, and the first normal gripping shape by which workpiece W is actually gripped do not always completely match. Thus, the shape of hand 12 at the start of step St5, which is the state in which hand 12 actually grips workpiece W, is registered (stored) as the first normal gripping shape.

The first shape (step St2) is just an estimated shape, whereas the first normal gripping shape (step St5) is the shape by which hand 12 actually grips workpiece W. Thus, the amount of information indicating the shape of hand 12 registered (stored) in memory 102 as the first normal gripping shape is larger (more accurate) than the amount of information indicating the shape of hand 12 estimated according to workpiece W. In an example using feature points, the number of feature points of the first shape (step St2) may be about 10, and the number of feature points of the first normal gripping shape (step St5) may be about 100.

Next, processor 101 controls robot arm 11 to move workpiece W to the start position of operation (step St6). During this movement, the shape of hand 12 maintains the first normal gripping shape.

In step St6, whether the first normal gripping shape is maintained can be detected based on the captured image captured by camera CAM. That is, it may be configured that processor 101 compares the information indicating the shape of hand 12 stored in memory 102 as the first normal gripping shape with the information indicating the current shape of hand 12 based on an image captured by camera CAM.

Then, when image acquisition unit 104 acquires an image captured by camera CAM and detects that hand 12 has taken a shape different from the first normal gripping shape based on the image, processor 101 controls hand 12 and robot arm 11 such that the shape of hand 12 returns to the first normal gripping shape.

For example, when workpiece W is heavier than expected, the gripped workpiece W may be likely to come off hand 12. In this case, the change in the shape of hand 12 is detected based on the image captured by camera CAM, and processor 101 can perform a control to increase the suction force of hand 12. If workpiece W has completely fallen off from hand 12, the parameters used for estimating the shape may be changed, for example, assuming that the estimation of the first shape is incorrect, and the process in step St1 and the subsequent steps may be performed again.

As described above, based on the control performed by control system 100, hand 12 gripping workpiece W can be moved to the start position of operation. In step St4, based on the image acquired by image acquisition unit 104, it is detected that hand 12 has taken a specific shape (first shape) (Yes in step St4), and a control is performed on the hand and the robot arm according to the specific shape. That is, processor 101 controls robot arm 11 to move workpiece W to the start position of operation (step St6).

Furthermore, processor 101 stores in memory 102 the shape that hand 12 takes when it is detected that hand 12 has taken the specific shape (first shape) (Yes in step St4) as detailed data (first normal gripping shape) indicating the specific shape (first shape), and based on the detailed data (first normal gripping shape) indicating the specific shape (first shape), processor 101 controls hand 12 and robot arm 11 so as to maintain the specific shape of hand 12 (step St6).

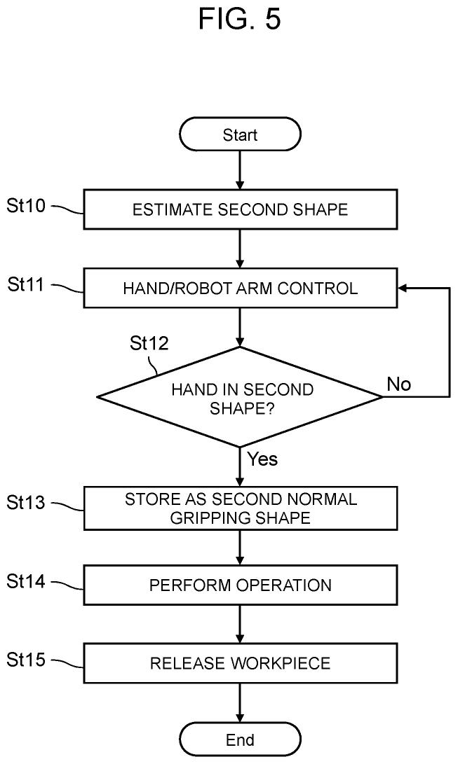

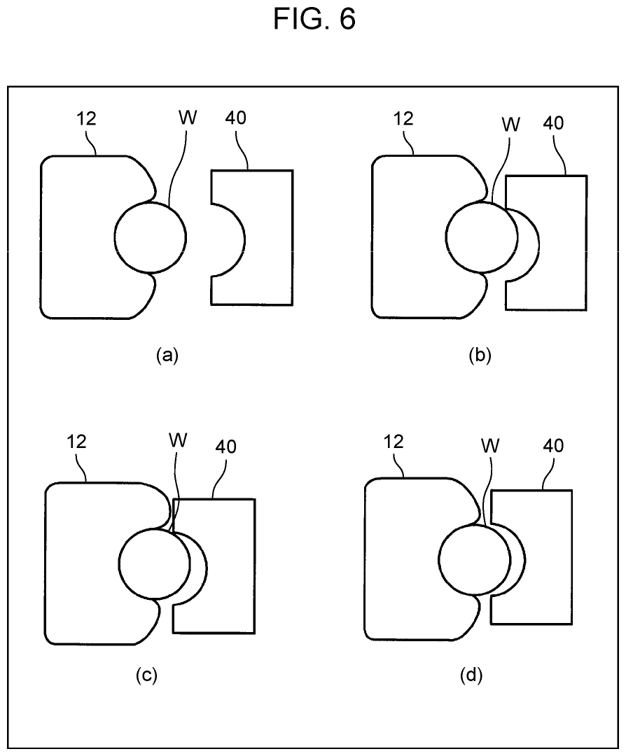

Next, an example of a control performed when an operation is performed for gripped workpiece W will be described with reference to FIG. 5. FIG. 5 is a flowchart illustrating an example of a control performed by control system 100 of the present disclosure. The operation includes fitting, connecting, and fixing of workpiece W to an object. Here, an operation of fitting workpiece W gripped by hand 12 to fit-target object 40 (see FIG. 6) will be described as an example. The outline of the whole operation is deforming hand 12 into a shape suitable for the operation for workpiece W, performing the operation, and releasing workpiece W after completion of the operation.

Processor 101 estimates the second shape (specific shape) of hand 12 according to the shape of workpiece W (step St10). The second shape is already illustrated in part (d) of FIG. 3.

Estimation of the second shape may be done in a manner similar to the estimation of the first shape (step St2) already described. Estimation may be done, for example, by processor 101 acquiring the information on the shape of hand 12 (contour, feature points on hand 12, etc.) according to workpiece W previously stored in memory 102 as a database. Alternatively, it may be configured that the relationship between workpiece W and the shape of hand 12 (contour, feature points on hand 12, etc.) is machine-learned to previously generate a learning model, the information related to workpiece W already recognized in step St1 is input to the learning model, and the estimated shape of hand 12 is output. Estimation of the shape of hand 12 may be done according to the shape of workpiece W as described above, or alternatively, according to the mass, surface roughness, hardness, etc. of workpiece W. Information indicating the mass, surface roughness, hardness, etc. of workpiece W may be input from input device 103 and stored in memory 102.

Next, processor 101 controls hand 12 and robot arm 11 such that hand 12 is deformed into the second shape (steps SW, St12). This control may be similar to that in steps St3 and St4 described above, and is as follows, for example.

Processor 101 controls hand 12 and robot arm 11 (step St11). For example, the suction force of hand 12 is reduced such that hand 12 is deformed from the state in part (c) of FIG. 3 to the state in part (d) of FIG. 3. Next, processor 101 determines whether the shape of hand 12 is the second shape (specific shape) (step St12). This determination may be made based on a captured image of hand 12 captured by camera CAM and acquired by image acquisition unit 104. If processor 101 determines that the shape of hand 12 is not the second shape (No in step St12), hand 12 and robot arm 11 are further controlled such that hand 12 takes the second shape (step St11). For example, the suction force of the vacuum suction unit of hand 12 is further reduced.

When processor 101 determines that the shape of hand 12 is the second shape (Yes in step St12), the current shape of hand 12 is registered (stored) in memory 102 as the second normal gripping shape (step St13). At this point, hand 12 grips workpiece W correctly in a state suitable for the operation.

Now, the estimation of the second shape in step St10 and the registration (storing) of the second normal gripping shape in step St13 will be described in more detail.

The second normal gripping shape of hand 12 gripping workpiece W (step St13) is a shape corresponding to the second shape of hand 12. However, hand 12 is deformable as described above. Thus, the second shape, which is the estimated shape, and the second normal gripping shape by which workpiece W is actually gripped in a state suitable for the operation for workpiece W do not always match completely. Thus, the shape of hand 12 at the start of step St13, which is the state in which hand 12 actually grips workpiece W, is registered (stored) as the second normal gripping shape.

The second shape (step St10) is just an estimated shape, whereas the second normal gripping shape (step St13) is a shape by which hand 12 actually grips workpiece W. Thus, the amount of information indicating the shape of hand 12 registered (stored) in memory 102 as the second normal gripping shape is larger (accurate) than the amount of information indicating the shape of hand 12 estimated according to workpiece W. In an example using feature points, the number of feature points of the second shape (step St10) may be about 10, and the number of feature points of the second normal gripping shape (step St13) may be about 100.

Next, processor 101 controls hand 12 and robot arm 11 to perform the operation (step St14). While the operation is performed, the shape of hand 12 maintains the second normal gripping shape.

In step St14, whether the second normal gripping shape is maintained can be detected based on the captured image captured by camera CAM. That is, it may be configured that processor 101 compares the information indicating the shape of hand 12 stored in memory 102 as the second normal gripping shape with the information indicating the current shape of hand 12 based on the image captured by camera CAM.

Then, when image acquisition unit 104 acquires the image captured by camera CAM and detects that hand 12 has taken a shape different from the second normal gripping shape based on the image, processor 101 controls hand 12 and robot arm 11 such that the shape of hand 12 returns to the second normal gripping shape. The return to the second normal gripping shape during the operation will be described later with reference to FIG. 6.

After the operation is completed, processor 101 controls hand 12 and robot arm 11 to release workpiece W (step St15).

As described above, the operation for gripped workpiece W can be performed based on the control performed by control system 100. In step St12, based on the image acquired by image acquisition unit 104, it is detected that hand 12 has taken a specific shape (second shape) (Yes in step St12), and a control is performed on the hand and the robot arm according to the specific shape. That is, processor 101 controls hand 12 and robot arm 11 to perform the operation (step St14).

Furthermore, processor 101 stores in memory 102 the shape that hand 12 takes when it is detected that hand 12 has taken a specific shape (second shape) (Yes in step St12) as detailed data (second normal gripping shape) indicating the specific shape (second shape), and based on the detailed data (second normal gripping shape) indicating the specific shape (second shape), processor 101 controls hand 12 and robot arm 11 so as to maintain the specific shape of hand 12 (step St14).

### (One Example of Returning to Second Normal Gripping Shape During Operation)

Hereinafter, an example of returning to the second normal gripping shape during operation will be described with reference to FIG. 6.

FIG. 6 is a schematic view illustrating an example of an operation performed by hand 12 gripping workpiece W. In FIG. 6, part (a) is at the start of operation, part (b) is at the start of interference between workpiece W and fit-target object 40, part (c) is when the shape of the hand is deformed, part (d) is when the shape of the hand returns to a second normal gripping shape. Similar to FIG. 5, an operation of fitting workpiece W gripped by hand 12 to fit-target object 40 will be described as an example.

At the start of operation (see part (a) of FIG. 6), workpiece W is not in contact with fit-target object 40 (e.g., a connector). Robot arm 11 is moved so as to push workpiece W against fit-target object 40, and workpiece W is fit in fit-target object 40. There may be a misalignment when fitting workpiece W to fit-target object 40. Thus, as illustrated in part (b) of FIG. 6, workpiece W may interfere (e.g., collide) with an object such as a connector end or the like of fit-target object 40.

Then, the shape of hand 12, which is a flexible hand, is deformed (see part (c) of FIG. 6). In other words, hand 12 takes a shape different from the second normal gripping shape. Camera CAM captures an image also during the fitting operation. Thus, processor 101 can detect deformation of hand 12 based on the image captured by camera CAM and acquired by image acquisition unit 104.

Upon detecting deformation of hand 12, processor 101 can control hand 12 and robot arm 11 so as the shape of hand 12 to return to the second normal gripping shape. For example, the position of hand 12 is corrected such that workpiece W does not collide with fit-target object 40. Part (d) of FIG. 6 illustrates the state after correcting the position of hand 12 by a control performed by processor 101. In the state in part (d) of FIG. 6, since workpiece W is not in contact with fit-target object 40, the shape of hand 12 returns to the original shape, which is the second normal gripping shape.

The interference between workpiece W and an object different from workpiece W (in the example, fit-target object 40) during the operation is not limited to collision, and may be a different kind of interference depending on the content of operation. For example, for an operation in outdoors, changing the grip of workpiece W may be needed due to external vibration, vibration of the workpiece itself, wind, or the like. The effect of such interference may be detected as deformation of hand 12 in a captured image, and hand 12 and robot arm 11 may be controlled so as hand 12 to return to the second normal gripping shape. The shape of hand 12 may be returned to the second normal gripping shape by means other than the above-mentioned positional movement of hand 12. For example, processor 101 may perform a control to increase or decrease the suction force of the vacuum suction unit of hand 12.

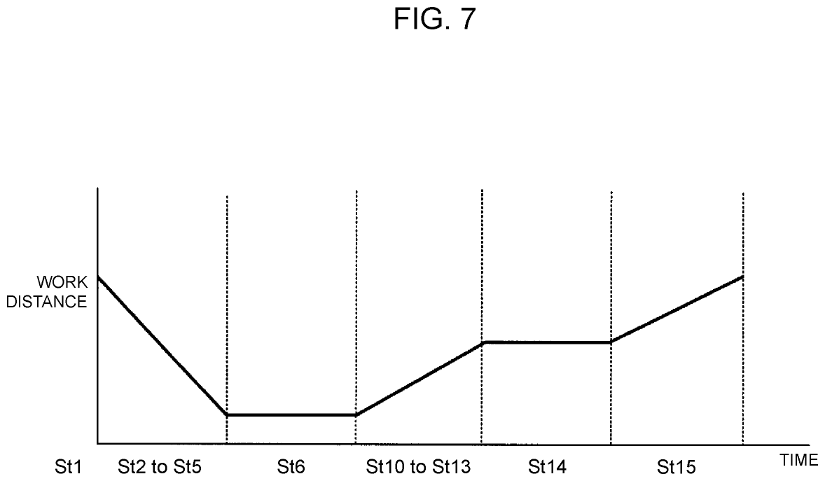

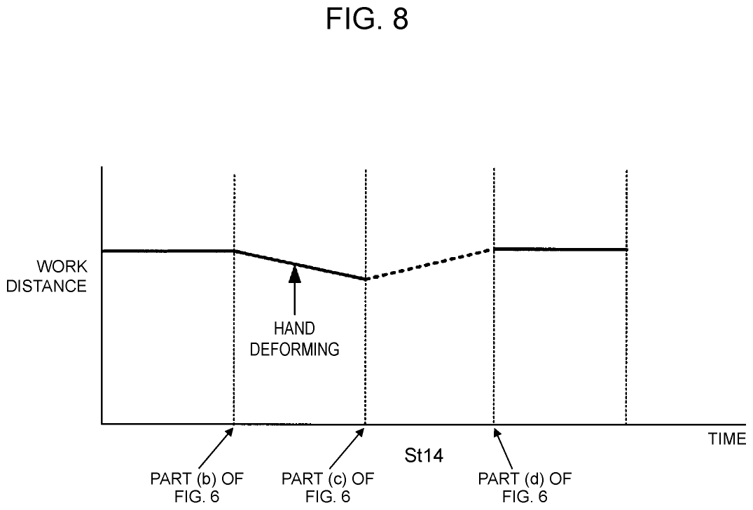

FIGS. 7 and 8 are graphs each illustrating an example of the change in work distance when hand 12 connected to robot arm 11 is controlled by control system 100 of the present disclosure. The work distance means the distance between hand 12 and workpiece W. The vertical axis of the chart is the work distance, and the horizontal axis is time.

FIG. 7 illustrates an example of the change in the work distance from gripping of workpiece W by hand 12 (steps St2 to St5) to releasing of workpiece W (step St15). When hand 12 grips workpiece W (steps St2 to St5), the work distance gradually decreases, and the shape of hand 12 changes to the first normal gripping shape (see part (c) of FIG. 3). During the movement to the start position of operation (step St6), the work distance is kept constant because the movement is performed with the first normal gripping shape maintained.

Before performing an operation such as fitting (steps St10 to St13), the shape of hand 12 is deformed from the first normal gripping shape (see part (c) of FIG. 3) to the second normal gripping shape (see part (d) of FIG. 3). Thus, the work distance gradually increases. At the time of performing the operation (step St14), the work distance is kept constant because the operation is performed with the second normal gripping shape maintained.

After performing the operation, hand 12 releases workpiece W, and the work distance increases and state illustrated in part (e) of FIG. 3 is established.

However, the operation performed by hand 12 is not always completed without any error. For example, as illustrated in part (b) in FIG. 6, workpiece W may interfere (collide) with a connector end or the like of fit-target object 40.

FIG. 8 illustrates an example of the change in the work distance when the collision error occurs during the operation (step St14). During the operation, hand 12 performs the operation while maintaining the second normal gripping shape, so that the work distance is constant when there is no error (see FIG. 7). However, as illustrated in part (b) of FIG. 6, when workpiece W interferes (collides) with the connector end or the like of fit-target object 40, workpiece W cannot be pushed further from there, and hand 12 is deformed, gradually decreasing the work distance.

Deformation of hand 12 is detected based on the image captured by camera CAM and acquired by image acquisition unit 104, and processor 101 performs a control to move the position of hand 12. Then, hand 12 returns to the second normal gripping shape. The work distance gradually increases and returns to the value at the original work distance.

In this manner, by controlling hand 12 connected to robot arm 11 based on the image captured by camera CAM and acquired by image acquisition unit 104, the work distance changes as illustrated in FIG. 7 and FIG. 8, for example.

As described above, the control system for hand 12 connectable to robot arm 11 includes image acquisition unit 104 that acquires an image of hand 12, and processor 101 that controls hand 12, hand 12 is, at least the shape of the tip is, deformable, processor 101 detects that hand 12 has deformed a specific shape based on the image acquired by image acquisition unit 104, and processor 101 controls hand 12 and robot arm 11 according to the specific shape.

Furthermore, in the control method for hand 12 connectable to robot arm 11 in a system including image acquisition unit 104 and processor 101, hand 12 is, at least the shape of the tip is, deformable, image acquisition unit 104 acquires an image of hand 12, processor 101 detects that hand 12 has deformed a specific shape based on the image acquired by image acquisition unit 104, and processor 101 controls hand 12 and robot arm 11 according to the specific shape.

Accordingly, the control system for hand 12 and the control method for hand 12 capable of determining a gripping state even for hand 12 having a deformable tip can be provided.

Furthermore, processor 101 stores in memory 102 the shape of hand 12 when it is detected that hand 12 has deformed a specific shape as detailed data indicating the specific shape, and based on the detailed data indicating the specific shape, processor 101 controls hand 12 and robot arm 11 to maintain the specific shape of hand 12. As a result, hand 12 and robot arm 11 can be controlled while hand 12 maintains the state in which workpiece W is correctly gripped.

Furthermore, processor 101 estimates the specific shape of hand 12 according to workpiece W which is a target of operation performed by hand 12. As a result, hand 12 can be deformed into an appropriate shape according to the shape, mass, surface roughness, hardness, etc. of workpiece W of various kinds, and workpiece W can be gripped appropriately.

Furthermore, while a control is performed on hand 12 and robot arm 11 according to a specific shape, processor 101 detects that hand 12 has deformed another shape different from the specific shape based on the image acquired by image acquisition unit 104, and controls hand 12 and robot arm 11 such that the other shape of hand 12 returns to the specific shape. As a result, even when a problem occurs in gripping workpiece W due to an event while hand 12 or robot arm 11 is being controlled, the problem can be detected based on an image and the state can be returned to the normal state.

Furthermore, processor 101 detects, based on the image acquired by image acquisition unit 104, that hand 12 has deformed another shape different from the specific shape due to collision between workpiece W gripped by hand 12 and an object, and controls hand 12 and robot arm 11 such that the other shape of hand 12 returns to the specific shape. As a result, even when workpiece W collides with an object such as a connector end or the like of fit-target object 40, deformation of hand 12 due to the collision can be detected based on the image and the state can be returned to the normal state.

Furthermore, the specific shape of hand 12 includes a first specific shape of hand 12 and a second specific shape of hand 12. Hand 12 has the first specific shape when moving while gripping workpiece W which is the target of operation. Hand 12 has the second shape when performing the operation while gripping workpiece W which is the target of operation. Accordingly, when hand 12 moves while gripping workpiece W which is the target of operation, and when hand 12 gripping workpiece W which is the target of operation performs the operation, hand 12 and robot arm 11 can be controlled with the normal gripping state maintained.

The present disclosure is useful as a control system for a hand and a control method for a hand capable of determining a gripping state even for a hand having a deformable tip.

What is claimed is:

1. A control system for a hand that is connectable to a robot arm and has a tip of which shape is deformable, the control system comprising:
an image acquisition unit configured to acquire an image of the hand; and
a controller configured to detect at least one specific deformed shape of the hand based on the image acquired by the image acquisition unit, and performs a control on at least one of the hand and the robot arm according to the at least one specific deformed shape detected.

2. The control system according to claim 1, wherein the controller stores in a memory a shape of the hand when the at least one specific deformed shape is detected as detailed data indicating the at least one specific deformed shape, and performs the control based on the detailed data to maintain the at least one specific deformed shape of the hand.

3. The control system according to claim 1, wherein the controller estimates the at least one specific deformed shape of the hand according to a workpiece that is a target of operation performed by the hand.

4. The control system according to claim 1, wherein the controller on detecting another shape of the hand different from the at least one specific deformed shape based on the image acquired by the image acquisition unit while controlling the at least one of the hand and the robot arm according to the at least one specific deformed shape, performs the control for causing the other shape of the hand to return to the at least one specific deformed shape.

5. The control system according to claim 4, wherein the controller on detecting, based on the image acquired by the image acquisition unit, the other shape of the hand different from the at least one specific deformed shape by a workpiece gripped by the hand colliding with an object, performs the control for causing the other shape of the hand to return to the at least one specific deformed shape.

6. The control system according to claim 1, wherein
the at least one specific deformed shape of the hand includes a first specific shape of the hand and a second specific shape of the hand,
the hand has the first specific shape when the hand moves while gripping a workpiece that is the target of operation, and
the hand has the second specific shape when the hand gripping the workpiece that is the target of operation performs operation.

7. A control method for a hand that is connectable to a robot arm and has a tip of which shape is deformable, the control method comprising:
acquiring an image of the hand;
detecting a specific deformed shape of the hand based on the acquired image; and
performing a control on at least one of the hand and the robot arm according to the specific deformed shape.
